(19) United States
(12) Patent Application Publication
(10) Pub. No.: US 2013/0226603 A1
(43) Pub. Date: Aug. 29, 2013

(54) Delivery of Medical Services Based on Observed Parametric Variation in Analyte Values

(71) Applicants: Stephen Suffin, Parsippany, NJ (US); Carl Garber, Mahwah, NJ (US)

(72) Inventors: Stephen Suffin, Parsippany, NJ (US); Carl Garber, Mahwah, NJ (US)

(21) Appl. No.: 13/616,342

(22) Filed: Sep. 14, 2012

Related U.S. Application Data
(63) Continuation of application No. 13/341,081, filed on Dec. 30, 2011, now abandoned.
(60) Provisional application No. 61/429,102, filed on Dec. 31, 2010.

(51) Int. Cl. G06F 19/00

(52) U.S. Cl. CPC G06F 19/366
USPC 705/2

(57) ABSTRACT

Laboratory testing plays a significant and growing role in the delivery of medical services. Fresh analysis of past test results has led to discovery of previously unknown correlations between statistical properties of analyte values and parameters such as age, sex, and region. Observed values in patient populations have also newly been discovered to show both secular and regular periodic variations over time. Embodiments of the invention may use information about these correlations to improve delivery of medical care.

### CROSS-REFERENCE TO RELATED APPLICATION

This application is a continuation of U.S. Nonprovisional application Ser. No. 13/341,081, filed 30 Dec. 2011 and titled “Improved Delivery of Medical Services Based on Observed Parametric Variation in Analyte Values”, and this application claims the benefit of U.S. Provisional Patent Application No. 61/429,102, filed 31 Dec. 2010 and titled “Improved Delivery of Medical Services Based on Observed Parametric Variation in Analyte Values”, which are incorporated herein by reference in their entirety, including all appendices thereto.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records but otherwise reserves all copyrights whatsoever.

### BACKGROUND

Laboratory testing plays a significant and growing role in the delivery of medical services. Existing testing systems and methods provide reference ranges for test results, but those systems, methods, and reference ranges fail to reflect newly-observed parametric variation in the measured values of the tested analytes.

### BRIEF SUMMARY OF THE INVENTION

Fresh analysis of past test results has led to discovery of previously unknown correlations between statistical properties of analyte values and parameters such as age, sex, and region. Observed values in patient populations have also newly been discovered to show both secular and regular periodic variations over time. Embodiments of the invention may use information about these correlations to improve delivery of medical care.

In an embodiment of the invention, a method is provided of calculating a reference range. The method comprises correlating with at least one time-periodic function a plurality of results of the medical test performed at a plurality of times upon a plurality of members of a population. The method also comprises calculating a reference range based at least on the time-periodic function.

In an embodiment of the invention, a method is provided of providing a medical test result. The method comprises receiving a medical test result that comprises a value for an analyte. The method also comprises retrieving a reference range for the analyte, the reference range being based at least on a time-periodic function and generating and transmitting a report that comprises the medical test result and the reference range.

In an embodiment of the invention, a method is provided of calculating a real age for a patient. The method comprises receiving a plurality of values, each respective value representing a result of a test within at least one longitudinal series of tests on the patient over a period of time. The method also comprises correlating one or more of the longitudinal series of results with one or more respective time-periodic functions that are known to correlate with results of the medical test in a population in a way that depends on the ages of members of the population. The method also comprises calculating a real age of the patient based at least on the degree to which one or more of the longitudinal series of results was correlated with one or more of the time-periodic functions and indicating the calculated real age of the patient.

In an embodiment of the invention, a method is provided of calculating a dose of a drug. The method comprises receiving a result of a laboratory test and a time at which the test was performed and selecting a reference range for the laboratory test, where the reference range has been calculated based on a time periodic function and the selection is based on the time at which the test was performed. The method also comprises comparing the result of the test with the reference range and calculating the dose of the drug based on the comparison between the result and the reference range.

In an embodiment of the invention, a method is provided of providing prescription drug benefits. The method comprises retrieving a reference range for an analyte, where there reference range is based at least on a time-periodic function. The method also comprises identifying a drug that may be prescribed for a patient in response to an detected abnormal value for the analyte in the patient and, based on the calculated reference range, calculating a prescription drug benefit that is to be provided for a patient who is prescribed the drug.

In an embodiment of the invention, a method is provided of providing medical testing services. The method comprises receiving a requisition for a test that is to be performed at least two times on a patient, the test comprising obtaining a value for an analyte. The method also comprises retrieving a reference range for the analyte, where the reference range is based at least on a time-periodic function. The method also comprises identifying respective occasions for performing the test on the patient based on the reference range, such that the time-periodicity of the function indicates that the tests on the patient may be expected to yield substantially different values.

In embodiments of the invention, some or all steps of some or all of the above-described methods may be performed by or in connection with one or more computer systems. Such a computer system, according to an embodiment of the invention, may include one or more processors, one or more interfaces operatively coupled to at least one of the processors, one or more databases, and/or one or more computer-readable storage media.

Embodiments of the invention also include computer systems programmed to carry out the above-described methods and computer-readable storage media encoded with instructions that, when executed by one or more processors within a computer system, cause the computer system to carry out the above-described methods.

### BRIEF DESCRIPTION OF THE DRAWINGS

FIG. 1 is a block diagram depicting an exemplary computer system with which embodiments of the invention may at least partially be implemented.

FIG. 2 is a block diagram depicting an exemplary interconnected network with which embodiments of the invention may at least partially be implemented.

FIG. 3 is a flow diagram depicting calculation of reference ranges according to an embodiment of the invention.

FIG. 4 is a flow diagram depicting provision of test results with reference ranges according to an embodiment of the invention.

### DETAILED DESCRIPTION OF PREFERRED EMBODIMENTS

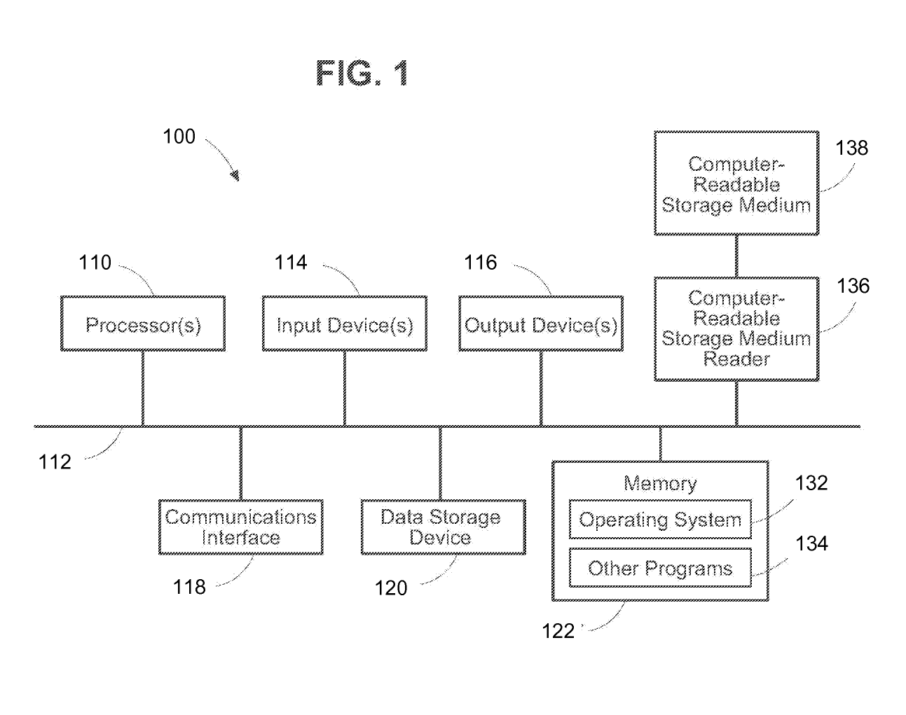

Embodiments of the invention may be implemented by systems using one or more programmable digital computers. FIG. 1 depicts an example of one such computer system 100, which includes at least one processor 110, such as, e.g., an Intel or Advanced Micro Devices microprocessor, coupled to a communications channel or bus 112. The computer system 100 further includes at least one input device 114 such as, e.g., a keyboard, mouse, touch pad or screen, or other selection or pointing device, at least one output device 116 such as, e.g., an electronic display device, at least one communications interface 118, at least one data storage device 120 such as a magnetic disk or an optical disk, and memory 122 such as ROM and RAM, each coupled to the communications channel 112. The communications interface 118 may be coupled to a network (not depicted) such as the Internet.

Although the computer system 100 is shown in FIG. 1 to have only a single communications channel 112, a person skilled in the relevant arts will recognize that a computer system may have multiple channels (not depicted), including for example one or more busses, and that such channels may be interconnected, e.g., by one or more bridges. In such a configuration, components depicted in FIG. 1 as connected by a single channel 112 may interoperate, and may thereby be considered to be coupled to one another, despite being directly connected to different communications channels.

One skilled in the art will recognize that, although the data storage device 120 and memory 122 are depicted as different units, the data storage device 120 and memory 122 can be parts of the same unit or units, and that the functions of one can be shared in whole or in part by the other, e.g., as RAM disks, virtual memory, etc. It will also be appreciated that any particular computer may have multiple components of a given type, e.g., processors 110, input devices 114, communications interfaces 118, etc.

The data storage device 120 (FIG. 1) and/or memory 122 may store instructions executable by one or more processors or kinds of processors 110, data, or both. Some groups of instructions, possibly grouped with data, may make up one or more programs, which may include an operating system 132 such as Microsoft Windows®, Linux®, Mac OS®, or Unix®. Other programs 134 may be stored instead of or in addition to the operating system. It will be appreciated that a computer system may also be implemented on platforms and operating systems other than those mentioned. Any operating system 132 or other program 134, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 100 (FIG. 1) may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 136, such as, e.g., a magnetic disk drive, magneto-optical drive, optical disk drive, or flash drive, may be coupled to the communications channel 112 for reading from a CRSM 138 such as, e.g., a magnetic disk, a magneto-optical disk, an optical disk, or flash RAM. Alternatively, one or more CRSM readers may be coupled to the rest of the computer system 100, e.g., through a network interface (not depicted) or a communications interface 118. In any such configuration, however, the computer system 100 may receive programs and/or data via the CRSM reader 136. Further, it will be appreciated that the term “memory” herein is intended to include various types of suitable data storage media, whether permanent or temporary, including among other things the data storage device 120, the memory 122, and the CSRM 138.

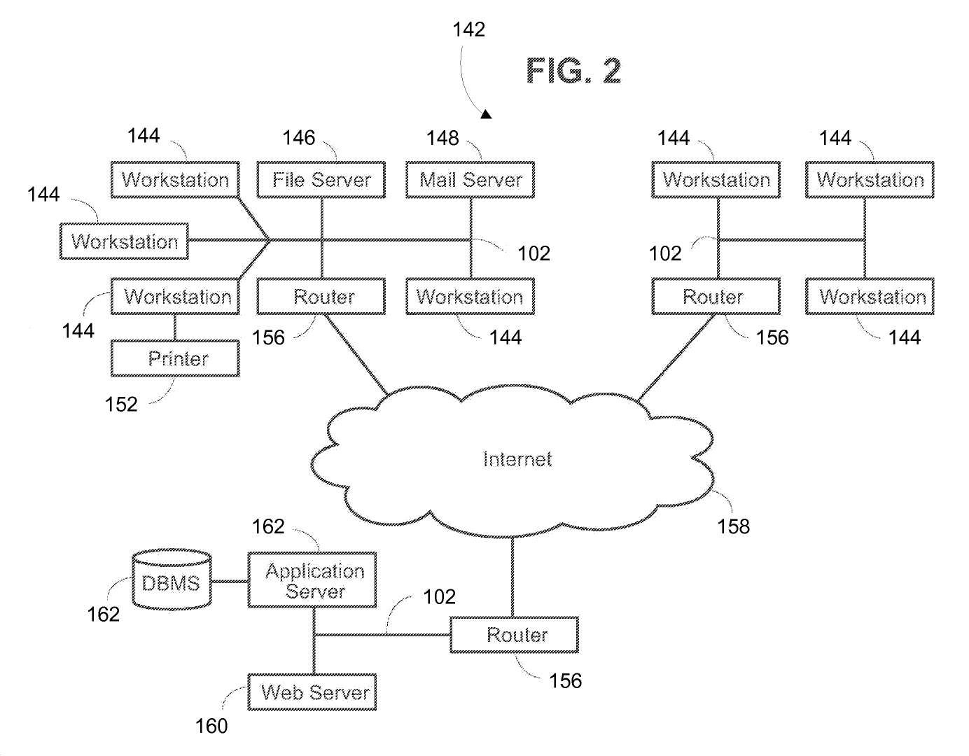

Two or more computer systems 100 (FIG. 1) may communicate, e.g., in one or more networks, via, e.g., their respective communications interfaces 118 and/or network interfaces (not depicted). FIG. 2 is a block diagram depicting an example of one such interconnected network 142. Network 142 may, for example, connect one or more workstations 144 with each other and with other computer systems, such as file servers 146 or mail servers 148. A workstation 144 may comprise a computer system 100. The connection may be achieved tangibly, e.g., via Ethernet® or optical cables, or wirelessly, e.g., through use of modulated microwave signals according to the IEEE 802.11 family of standards. A computer workstation 144 or system 100 that participates in the network may send data to another computer workstation system in the network via the network connection.

One use of a network 142 (FIG. 2) is to enable a computer system to provide services to other computer systems, consume services provided by other computer systems, or both. For example, a file server 146 may provide common storage of files for one or more of the workstations 144 on a network 142. A workstation 144 sends data including a request for a file to the file server 146 via the network 142 and the file server 146 may respond by sending the data from the file back to the requesting workstation 144.

Further, a computer system may simultaneously act as a workstation, a server, and/or a client. For example, as depicted in FIG. 2, a workstation 144 is connected to a printer 152. That workstation 144 may allow users of other workstations on the network 142 to use the printer 152, thereby acting as a print server. At the same time, however, a user may be working at the workstation 144 on a document that is stored on the file server 146.

The network 142 (FIG. 2) may be connected to one or more other networks, e.g., via a router 156. A router 156 may also act as a firewall, monitoring and/or restricting the flow of data to and/or from the network 142 as configured to protect the network. A firewall may alternatively be a separate device (not pictured) from the router 156.

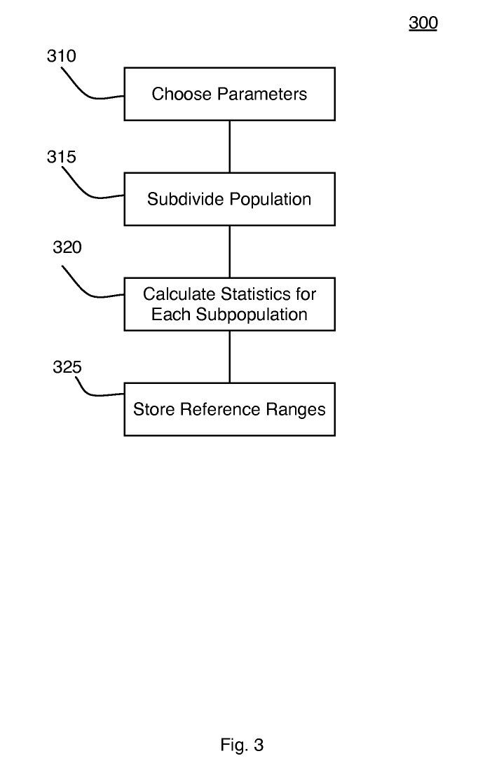

An internet may comprise a network of networks 142 (FIG. 2). The term “the Internet” refers to the worldwide network of interconnected, packet-switched data networks that uses the Internet Protocol (IP) to route and transfer data. In the example depicted in FIG. 3, the Internet 158 provides a communications network over which computer systems in network 142 communicate. For example, a client and server on different networks may communicate via the Internet 158, e.g., a workstation 144 may request a World Wide Web document from a Web Server 160. The Web Server 160 may process the request and pass it to, e.g., an Application Server 162. The Application Server 162 may then conduct further processing, which may include, for example, sending data to and/or receiving data from one or more other data sources. Such a data source may include, e.g., other servers on the same computer system 100 or LAN 102, or a different computer system or LAN and/or a Database Management System (“DBMS”) 162.

As will be recognized by those skilled in the relevant art, the terms “workstation,” “client,” and “server” are used herein to describe a computer's function in a particular context. A workstation may, for example, be a computer that one or more users work with directly, e.g., through a keyboard and monitor directly coupled to the computer system. A computer system that requests a service through a network is often referred to as a client, and a computer system that provides a service is often referred to as a server. But any particular workstation may be indistinguishable in its hardware, configuration, operating system, and/or other software from a client, server, or both.

The terms “client” and “server” may describe programs and running processes instead of or in addition to their application to computer systems described above. Generally, a (software) client may consume information and/or computational services provided by a (software) server.

In connection with embodiments of the invention, one or more computer systems, which may be interconnected, e.g., to each other and/or to other computer systems, may calculate and/or store, retrieve, manipulate, analyze, transmit, and/or receive data related to values of analytes measured, e.g., in laboratory tests. An analyte is a substance that is being identified or is the subject of a measurement in a test. Strictly speaking, the measurement is not of an analyte itself, but, rather, is of a quantity related to that analyte, such as the concentration of that analyte in a sample being tested. For example, a test may measure the concentration of glucose in blood serum; in such a test, glucose is the analyte. Nonetheless, a common shorthand is to refer to measurement of an analyte, and the correct meaning is clear from context.

Analyte values measured in medical laboratory tests commonly reflect or approximate a normal or log-normal distribution. Based on this fact, a “reference range” may be established for a particular test and/or analyte. A reference range for a particular test or measurement is usually defined as the prediction interval of values that 95% (or 2 standard deviations) of the population fall into. Depending on the circumstances, the reference range may be established with regard to an entire population or only a healthy population.

Reference ranges may often—but nonetheless incorrectly—be regarded as establishing “normal” values for analytes. Not everyone manifesting a value outside the reference range is abnormal or unhealthy, however, and not everyone within the reference range is healthy or free of tested—for medical conditions. Nonetheless, reference ranges may be considered useful for diagnosis, e.g., as indicating possible avenues for follow-up; it is apparent that a value for a patient that is outside the commonly-observed range of values may in fact be abnormal and an indication that a medical condition exists.

It will therefore be appreciated that the diagnostic utility of a reference range may be highest if the range best reflects the range of expected values from the relevant population. In some cases, existing reference ranges reflect that fact. For example, the distributions of values of, e.g., estrogen, testosterone, and prostate-specific antigen (PSA), measured in men will differ from that of values measured in women, and separate reference ranges for may consequently be established for men and women.

As has been discovered through the applicants' analyses of historical test results, however, mean values and standard deviations for many analytes vary depending on the patient's age, sex, and location. Both secular and regular periodic variation based on time have also been observed. In many cases, the observed mean values over time may be fit to a curve with a high degree of correlation, with the same curve fitting to different sub-populations with variations only in the coefficients of polynomial and/or time-periodic terms in the equation.

Periodic variations may be attributed in some cases to environmental factors, in some cases to behavioral factors, and in some cases to both. For example, vitamin D levels might vary seasonally reflecting both the seasonal variation in the length and intensity of sunlight reaching the Earth's surface each day and the relative time spent indoors and outdoors, e.g., in summer versus winter. In some populations, for example, a vitamin D level of 22 ng/mL might be expected in March, but should not be seen in August.

As another example, in some populations, cholesterol levels may increase in late fall and winter, reflecting holiday indulgence, while falling in the late spring and summer as people may lose weight to look more attractive in swimsuits. In such a population, a total cholesterol level of 200 mg/dL might be expected in January but not in July.

According to embodiments of the invention, one or more parameters such as age, sex, location (which may be expressed, e.g., in terms of political or geographic regions), and time may be used to calculate one or more reference ranges for an analyte. For example, one or more of these parameters may be used to select sub-populations of historical test results. One or more such selected sub-populations may then be subjected to statistical analysis, e.g., as is known in the art, to calculate respective reference ranges.

In an embodiment of the invention, reference ranges that have been calculated as above may be associated with the values of the parameters used to select the population. In such an embodiment, corresponding parameters may be recorded with a subsequent performance of test. Such parameters may be used to select a reference range most applicable to that performance, and that reference range may then be, e.g., reported along the with test result to a prescribing physician and/or used to help judge whether the test result indicates an abnormal medical condition, among other uses.

FIG. 3 depicts generation 300 of reference ranges based on stored results of previous tests, according to an embodiment of the invention. As depicted, the process begins in block 310 with selection of the parameters used to subdivide the population of results. The selection of parameters may depend, e.g., on the data associated with the recorded test results and/or the known variance and/or invariance of analyte values based on various parameters.

Selection of parameters may also depend on the nature of the values. A parameter such as sex may be effectively binary. Other parameters, such as age or time, may be effectively continuous, and parameters may be specified as ranges. For example, an age parameter may be expressed as a range of values, e.g., 0-6 (years), 7-13, 14-21, 21-30, etc. Time may be expressed, e.g., as a month, season, range of days, etc. It will be appreciated that the division into ranges for this purpose may reflect the expected statistical properties of the analyte within and between ranges, e.g., to minimize the expected variation within each range.

Once the parameters have been selected, e.g., as above, in block 310, in an embodiment of the invention, the population of test results may be subdivided in block 315, e.g., into sub-populations based on the parameter values associated with each test result. Statistics for each sub-population may be calculated in block 320. For example, if analyte values follow a normal distribution, in an embodiment of the invention, the mean and standard deviation for the values in each sub-population may be computed. Corresponding calculations, e.g., such as are known in the art, may similarly take place for analytes whose values follow log-normal or other distributions.

The statistical calculation in block 320 may in an embodiment of the invention be the basis for the calculation of reference ranges. For example, in an analyte whose values follow a normal distribution, for each sub-population, a separate reference range may be established, e.g., of two standard deviations (for that sub-population) around the mean (also for that sub-population). The respective reference ranges may then in block 325 be stored, e.g., for future reference.

It will be appreciated that in an embodiment of the invention, some or all of the steps depicted in FIG. 3 may be performed by or in connection with one or more computer systems. For example, the historical analyte values may be stored electronically, e.g., by a DBMS, and retrieved for processing. A computer system may perform one or more statistical analyses and/or calculations, e.g., as described herein. One or more references ranges calculated as described may be stored, e.g., in a computer-readable storage medium by a DBMS for subsequent retrieval.

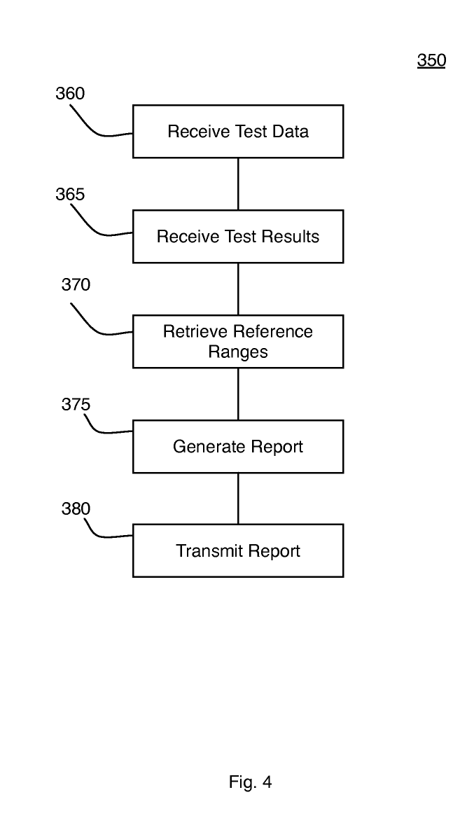

FIG. 4 depicts generation 350 of a medical report incorporating reference ranges according to an embodiment of the invention. The process begins in block 360 with receipt by a laboratory of information about a test to be performed on a patient. The information may be received, e.g., as a written, printed, or electronic test requisition, which may include information such as, e.g., the patient's demographic information, specification of one or more tests, and information about the ordering physician.

One or more specimens, e.g., of body fluids and/or tissues, may be obtained from the patient and subjected to one or more assays. The assay or assays may result in a measurement of a value for an analyte. As depicted, this result is received, e.g., electronically or in written form, in block 365.

In block 370, the test information, e.g., as received in a requisition in block 360, is used to select a reference range for the analyte applicable to the test. This reference range may be a seasonal or other periodic range, e.g., selected based on the date and/or time that the test was administered.

In block 375, a report is generated. This report may include information about the test, which may include some or all of, e.g., patient information, identification of the testing methodology, location, and/or apparatus, one or more diagnosis codes. In an embodiment of the invention, the report may comprise identification of the measured analyte, the measured value, and the reference range selected and/or retrieved in block 370. The report as generated in block 375 may be tangible, e.g., written or printed on paper, or electronic, e.g., a representation of the reported information, linked together, in a computer memory and/or computer-readable storage medium.

In block 380, the report is transmitted. A paper report may be, e.g., mailed, faxed, or otherwise conveyed to the ordering physician and/or patient. An electronic report may be, e.g., transmitted to a local or remote printer, and/or transmitted electronically, e.g., for delivery and/or further processing.

For some analytes, periodic variation may be present in some populations but not for others. For example, levels of the enzyme alkaline phosphatase show regular seasonal variation in persons under 20 years of age. After age 20, however, little or no seasonal variation has been observed.

Thus, according to an embodiment of the invention, an analyte in a single patient may be measured several times, e.g., throughout a year. The values measured during that year may be examined for fluctuations that correspond to a known periodic variation that depends on the patient's age. The presence or absence of such corresponding variation and/or the magnitude of any detected periodic variation in the patient may be taken to mean that the patient's body is exhibiting characteristics that normally correspond to persons in a known age range. Such an age range, determined with reference to one or more analytes, may be taken as a “real” age for a patient. In an embodiment of the invention, a method may comprise calculating such a real age based on the values measured for one or more analytes over time.

It is known that exhibiting abnormal values for one or more analytes may itself be considered a medical condition and further that some such conditions may be treated, e.g., through administration of one or more drugs. The analyses indicate, however, that normal values for some analytes may fluctuate throughout the year. According to an embodiment of the invention, these facts may be used to calculate an appropriate drug dosage. That is, given one or more measured values for an analyte, information about the patient, and information about the time, which may include information about or related to the current season, the degree of deficiency or excess of the analyte may be determined. A drug and/or dosage appropriate to this temporally-adjusted deficiency or excess may be calculated, and, further, may be varied over time to match temporal variation in this deficiency or excess.

Conversely, however, time-based variation in values for an analyte in a patient may indicate that the patient exhibits abnormal levels only some of the time, e.g., during certain seasons. Accordingly, measured time dependency of values for an analyte may indicate that a patient exhibits deficiency or excess only in certain predictable periods. In an embodiment of the invention, a drug and/or dosage may be prescribed for a patient, with the drug, dosage, or period of administration calculated to address the time-limited excess or deficiency.

In some cases, the cost of a drug is not borne directly by a patient (or a person responsible for that patient), but is covered by a prescription or pharmacy benefit plan, e.g., as provided by an employer or other sponsor. Such plans may be administered by a pharmacy benefits manager (PBM). As is well known, such a plan may apply one or more formularies to determine the benefits available to a covered person for different drugs. A drug may be said to be on the formulary if the plan pays for it in whole or in part, and it may be said to be off the formulary otherwise. Formularies may have tiers of benefits and/or drugs, such that a patient may, e.g., bear relatively less of the cost of drug on a preferred tier than of one on a non-preferred tier. Formularies and/or other coverage guidelines or policies may include other limitations, including, e.g., limitations related to dosage forms and/or amounts and/or the length of time a particular drug will be covered.

Prescription benefits (including formulary status) may vary, even within a single sponsor and plan, based on a patient's known medical conditions. In an embodiment of the invention, such medical conditions may include measured periodic excess or deficiency of one or more analytes. Benefits for a drug for a covered patient may vary, e.g., over time, reflecting, e.g., time-based variation in appropriate drugs and/or dosing such as described above.

1. A computer system for calculating a reference range, the computer system comprising:
one or more processors; and
one or more computer-readable storage media encoded with instructions that, when executed by at least one of the processors, cause the computer system at least to
correlate with at least one time-periodic function a plurality of results of the medical test performed at a plurality of times upon a plurality of members of a population; and
calculate a reference range based at least on the time-periodic function.

2. A computer system for providing a medical test result, the computer system comprising:
one or more processors;
one or more hardware interfaces;
one or more databases; and
one or more computer-readable storage media encoded with instructions that, when executed by at least one of the processors, cause the computer system at least to
receive through at least one of the hardware interfaces a medical test result that comprises a value for an analyte;
retrieve from at least one of the databases a reference range for the analyte, the reference range being based at least on a time-periodic function; and
transmitting through at least one of the hardware interfaces a report that comprises the medical test result and the reference range.

3. A computer system for calculating a real age for a patient, the computer system comprising:
one or more processors;
one or more hardware interfaces;
one or more databases; and
one or more computer-readable storage media encoded with instructions that, when executed by at least one of the processors, cause the computer system at least to
receive through an interface coupled to at least one of the processors a plurality of values, each respective value representing a result of a test within at least one longitudinal series of tests on the patient over a period of time;
correlate one or more of the longitudinal series of results with one or more respective time-periodic functions, stored in the database, that are known to correlate with results of the medical test in a population in a way that depends on the ages of members of the population;
calculate a real age of the patient based at least on the degree to which one or more of the longitudinal series of results was correlated with one or more of the time-periodic functions; and
provide output through at least one of the interfaces indicating the calculated real age of the patient.

4. A computer system for calculating a dose of a drug, the computer system comprising:
one or more processors;
one or more hardware interfaces;
one or more databases; and
one or more computer-readable storage media encoded with instructions that, when executed by at least one of the processors, cause the computer system at least to
receive through at one or more interfaces coupled to at least one of the processors a result of a laboratory test and a time at which the test was performed;
select a reference range for the laboratory test, the reference range having been calculated based on a time periodic function and the selection being based on the time at which the test was performed;
compare the result with the reference range; and
calculate the dose of the drug based on the comparison between the result and the reference range.

5. A computer system for providing prescription drug benefits, the computer system comprising:
one or more processors;
one or more databases; and
one or more computer-readable storage media encoded with instructions that, when executed by at least one of the processors, cause the computer system at least to
retrieve from at least one of the databases a reference range for the analyte, the reference range being based at least on a time-periodic function;
identify a drug that may be prescribed for a patient in response to an detected abnormal value for the analyte in the patient; and
based on the calculated reference range, calculate a prescription drug benefit that is to be provided for a patient who is prescribed the drug.

6. A computer system for providing medical testing services, the computer system comprising:
one or more processors;
one or more hardware interfaces;
one or more databases; and
one or more computer-readable storage media encoded with instructions that, when executed by at least one of the processors, cause the computer system at least to
receive through at least one of the interfaces a requisition for a test that is to be performed at least two times on a patient, the test comprising obtaining a value for an analyte;
retrieve from at least one of the databases a reference range for the analyte, the reference range being based at least on a time-periodic function;
identify respective occasions for performing the test on the patient based on the reference range, such that the time-periodicity of the function indicates that the tests on the patient may be expected to yield substantially different values.
